(19) United States
(12) Patent Application Publication
(10) Pub. No.: US 2010/0097791 A1
(43) Pub. Date: Apr. 22, 2010

(54) LIGHT EMITTING DIODE (LED) STRIP LIGHT

(76) Inventor: Kai-Nan CHANG, Taichung City (TW)

Correspondence Address: EGBERT LAW OFFICES, 412 MAIN STREET, 7TH FLOOR, HOUSTON, TX, 77002, US

(21) Appl. No.: 12/253,969

(22) Filed: Oct. 18, 2008

(51) Int. Cl. F21L 4/00; F21V 1/00

(52) U.S. Cl. 362/190; 362/235

(57) ABSTRACT

The present invention provides an LED strip light, including a flexible strip body, which contains a flexible FPC, a plurality of LEDs arranged at interval on one side of flexible FPC, and a flexible light-transmitting layer adapted on one side of the flexible FPC. The flexible light-transmitting layer is used for covering and sealing the LEDs. An optical diffuse surface is formed on the flexible light-transmitting layer. An electrical connector is electrically connected to at least one end of the flexible FPC of the flexible strip body. With the present invention, a thin-profile LED strip light is realized, improving operational flexibility and integration effect and contributing to the electrical connection's expansion of the LED strip light with improved applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a light-emitting diode (LED) light, and more particularly to an innovative light structure with a flexible LED strip.

2. Description of Related Art Including Information Disclosed Under 37 CFR 1.97 and 37 CFR 1.98.

There is a growing trend in light-emitting diodes (LEDs) being more commonly used due to advantages in energy-saving, longer service life and smaller space.

The existing LED lights are available in a variety of models, e.g. light bulbs, light boards and lamps. Moreover, the flexible LED strip light is an up-to-date LED light.

The present invention is intended to improve upon the typical LED strip light structure, which is generally designed in a manner wherein the circuit substrate, LED and drive device are encapsulated into a flexible strip translucent material. One end of the circuit substrate is linked to a preset power switch by penetrating a wire outside of the translucent material; however, it is found during actual application that, as the circuit substrate, LED and drive device must be encapsulated into a translucent material, the excessively bulky space will affect seriously the operational flexibility, leading to poorer effect when it is affixed onto the surface of products. On the other hand, the electrical connection and expansion capacity are not considered, making it difficult to satisfy diversified demands due to shortcomings and disadvantages in the applications.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the innovative feature of the flexible strip body, the LED are covered and sealed by the flexible light-transmitting layer assembled and adapted on one side of the flexible FPC. A thin flexible light-transmitting layer is enough for this purpose, so the flexible strip body can be implemented by a thin-profile model, thus improving greatly the flexibility and realizing an excellent adhesion effect with greater industrial benefits.

Based on the innovative feature of the electrical connector, the electrical connector being assembled at one end of the flexible strip body, the LED strip light and the preset power supply module or connection receptacle can be assembled very conveniently and quickly. The expansion capability of the LED strip contributes to electrical connection for improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the preferred embodiment of the present invention.

FIG. 2 shows a sectional view of the flexible strip body of the present invention.

FIG. 3 shows an exploded perspective view of the power supply module of the present invention.

FIG. 4 shows an assembled sectional view of the power supply module of the present invention.

FIG. 5 shows an assembled sectional view of the power supply module of the present invention under operational state.

FIG. 6 shows sectional view of another application for assembly of the flash control integrated circuit (IC) of the present invention.

FIG. 7 shows a perspective view of an application of the present invention, showing the LED strip light assembled onto a cap.

FIG. 8 shows another perspective view of the preferred embodiment in FIG. 7.

FIG. 9 shows another perspective view of the application of the connection receptacle of the present invention.

FIG. 10 shows another exploded perspective view of the application of the local member of power supply module of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

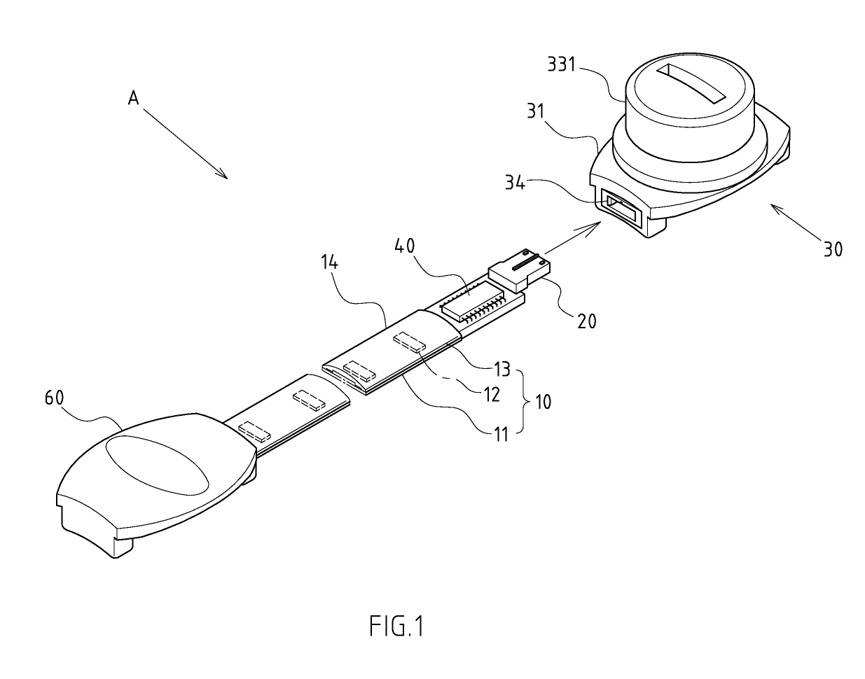

FIGS. 1-4 depict preferred embodiments of the LED strip light of the present invention. The embodiments are provided only for explanatory purposes with respect to the patent claims.

The LED strip light A comprises a flexible strip body 10, which comprises a flexible FPC 11, a plurality of LEDs 12 arranged at intervals on one side of flexible FPC 11, and a flexible light-transmitting layer 13 adapted on one side of the flexible FPC 11. The flexible light-transmitting layer 13 is used for covering and sealing the LEDs 12. Moreover, an optical diffuse surface 14 is formed on the flexible light-transmitting layer 13. The optical diffuse surface 14 has a convex arc that can generate an optical diffusion effect.

At least an electrical connector 20 connects electrically to at least one end of the flexible FPC 11 of the flexible strip body 10.

A power supply module 30 comprises a base 31, a battery 32, a switching member 33 and an electrical connection base 34. The electrical connection base 34 is used for electrical connection by the electrical connector 20, thus providing a power supply required by LED 12 of the flexible strip body 10.

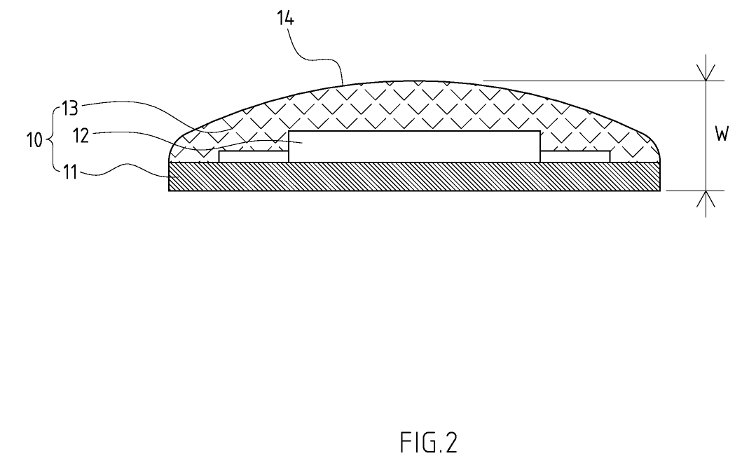

The flexible strip body 10 has an actual thickness (marked by W in FIG. 2) between 1 mm-3 mm, forming a thin-profile structure as compared to a typical LED strip light.

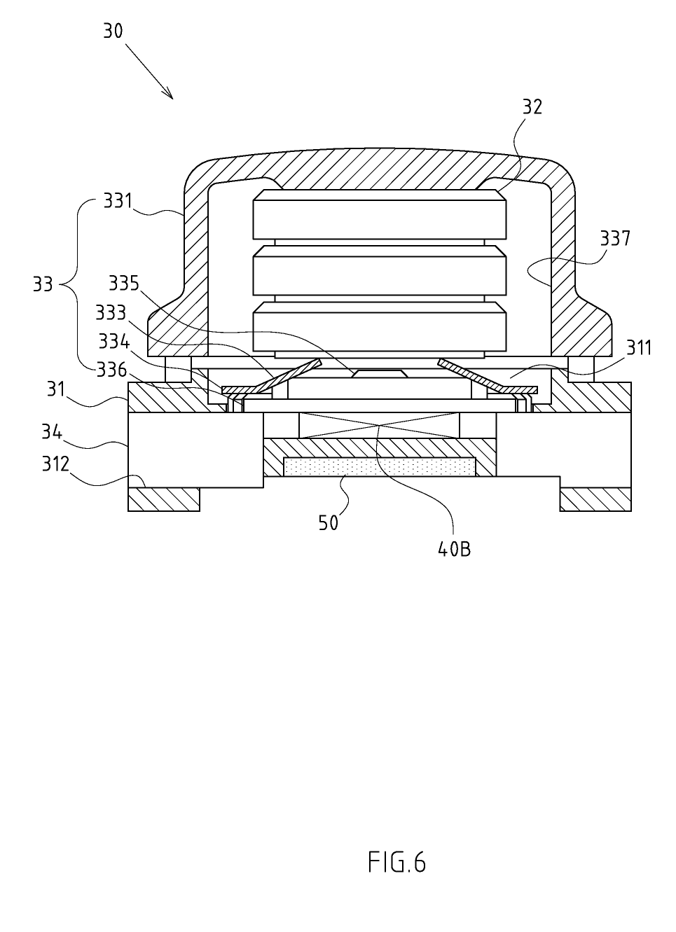

The LED strip light A comprises a flash control IC 40. Referring to FIG. 1, the flash control IC 40 is mounted into the flexible strip body 10, and electrically connected with one end of the flexible FPC 11. Referring to FIG. 6, the flash control IC 40B is mounted into the power supply module 30. So, the flash control ICs 40, 40B are mounted to control the flash mode of LED 12.

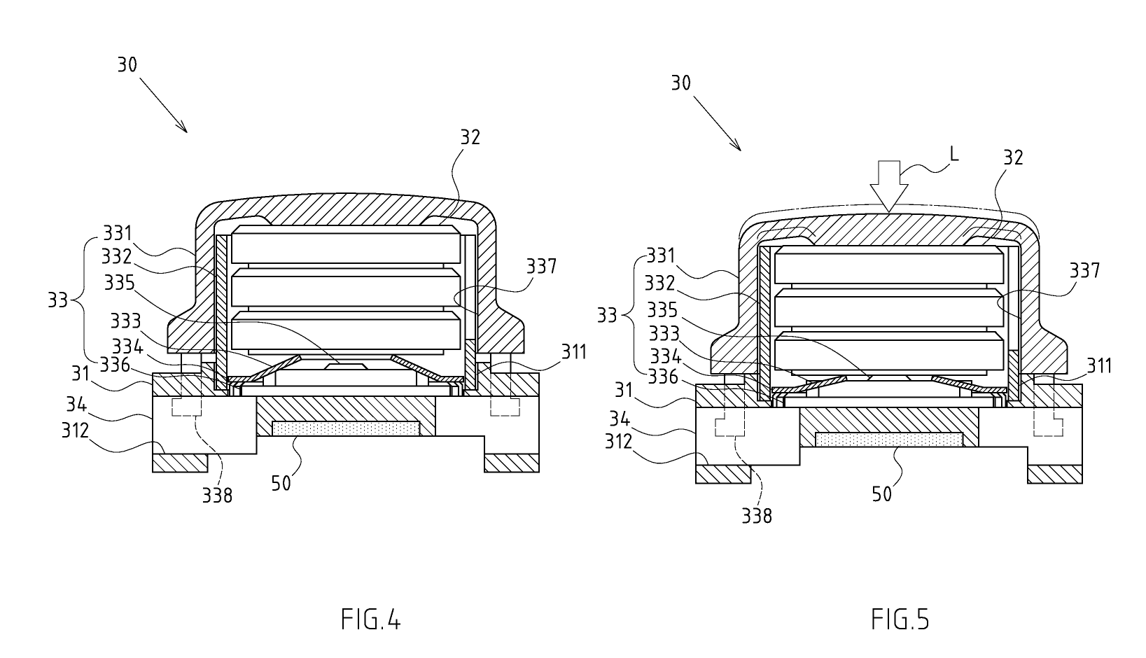

The base 31 of power supply module 30 comprises an upper groove 311 and a lateral trough 312. The lateral trough 312 is used for the assembly of electrical connection base 34. The switching member 33 comprises a push button 331, a conductive assembly 332, a conductive base 334 with a plurality of flexible bracings 333, and a circuit board 336 with press key 335. The push button 331 is assembled onto the base 31 for shifting to a predefined distance under pressure. A hold tank 337 is defined in the push button 331 (shown in FIG. 4) to accommodate the battery 32. The conductive assembly 332 (a C-shaped cylinder) is assembled into hold tank 337 and linked to the cathode of the battery 32. The conductive base 334 and circuit board 336 are assembled into the upper groove 311 of the base 31. Moreover, the flexible bracing 333 of the conductive base 334 is used to support the bottom of the battery 32 and link the cathode of the battery 32 while supporting flexibly the push button 331 for normal resetting. The flexible bracing 333 of the preferred embodiment is formed as a gripper extending obliquely upwards, whilst the press key 335 of the circuit board 336 is located correspondingly below the battery 32. Referring to FIG. 5, when the push button 331 is pushed (indicated by arrow L in the figure) to make the battery 32 fall down simultaneously, the press key 335 is pressed down to control on/off state of the power supply. Alternatively, the press key 335 can be set in a manner that the power supply is turned on if it is pressed one time, or turned off if it is pressed once more.

L-shaped coupling LED 338 and the rotating groove are arranged correspondingly between the push button 331 and base 31, such that the push button 331 can be inserted and rotated for secure positioning.

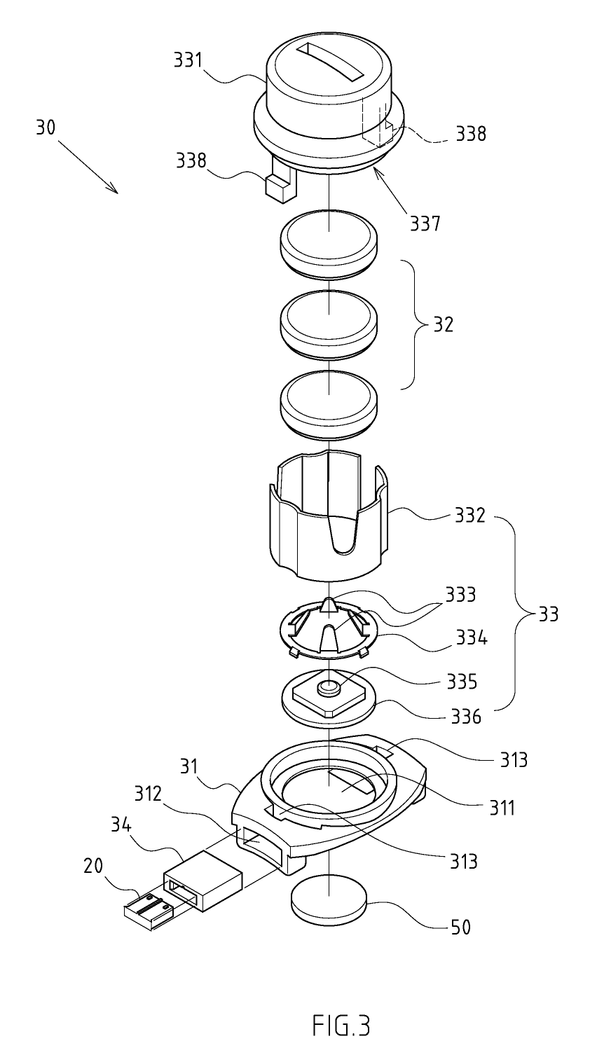

A locating member 50 is mounted at the bottom of base 31 of the power supply module 30. The locating member 50 is made of either of the following materials: magnetic body, double-sided tape, fastening tape and adhesive. Referring to FIGS. 3 and 4, the locating member 50 of the preferred embodiment is a magnetic body, enabling the power supply module 30 to be assembled and located on the preset magnetic target.

The LED strip light A also comprises a connection receptacle 60, which is assembled at one end of the flexible strip body 10. The connection receptacle 60 can be used as a locating member of the LED strip light A for convenient assembly and positioning onto predefined product.

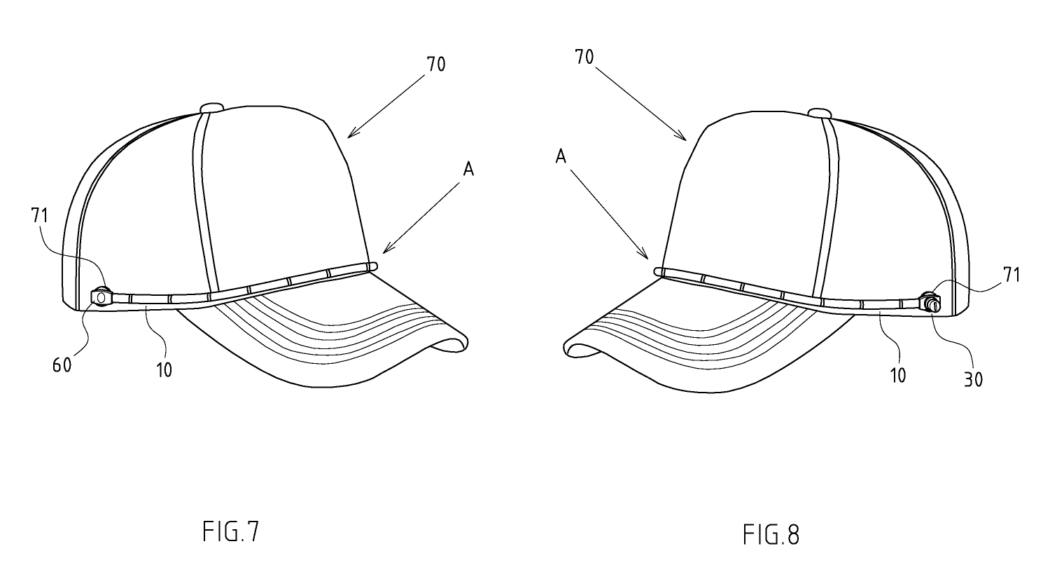

Based upon above-specified structures, the LED strip light of the present invention is operated as shown in FIGS. 7 and 8. It can be assembled onto a cap 70 as a warning or decorative lamp. As for the assembly of the LED strip light A and the cap 70, metal staples 71 are arranged beforehand at both sides of the cap 70. So, the bottom of the base 31 of the power supply module 30 of LED strip light A can be adsorbed onto the metal staple 71 at one side of the cap 70 through the magnetic locating member 50 (shown in FIGS. 3 and 4). The bottom of the connection receptacle 60 at the other end of the LED strip light A can be provided with a magnetic locating member, so that it can be adsorbed onto the metal staple 71 at the other side of the cap 70. In this way, the LED strip light A can be assembled onto the cap 70 securely without loosening and can also be disassembled very conveniently. The flexible strip body 10 of the LED strip light A can be abutted with top of the front brim of the cap 70 to realize obviously a irradiation effect.

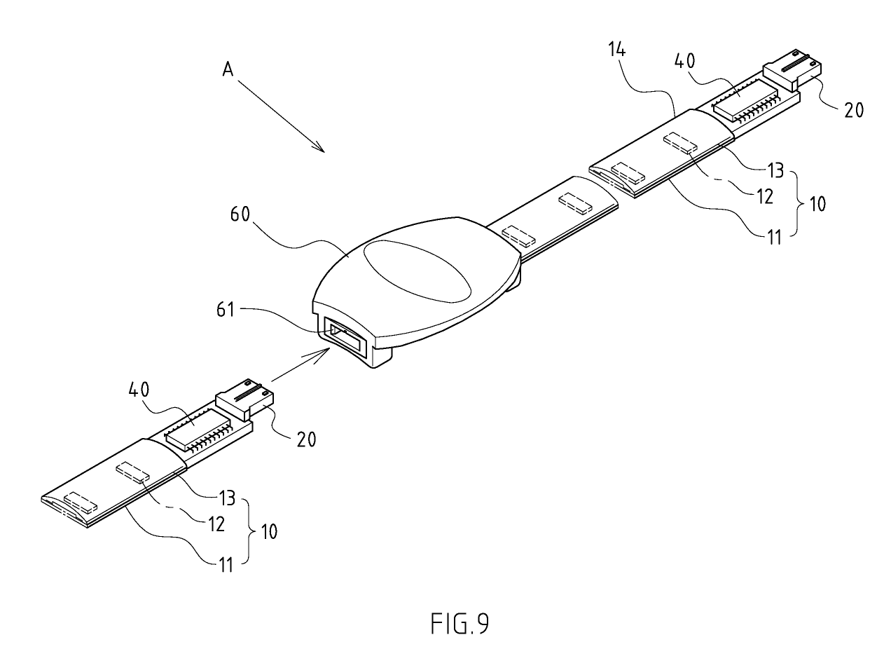

Referring also to FIG. 9, the connection receptacle 60 is also provided with at least two electrical sockets 61, allowing to connect the electrical connector 20 of at least two flexible strip bodies 10 for serial connection purpose.

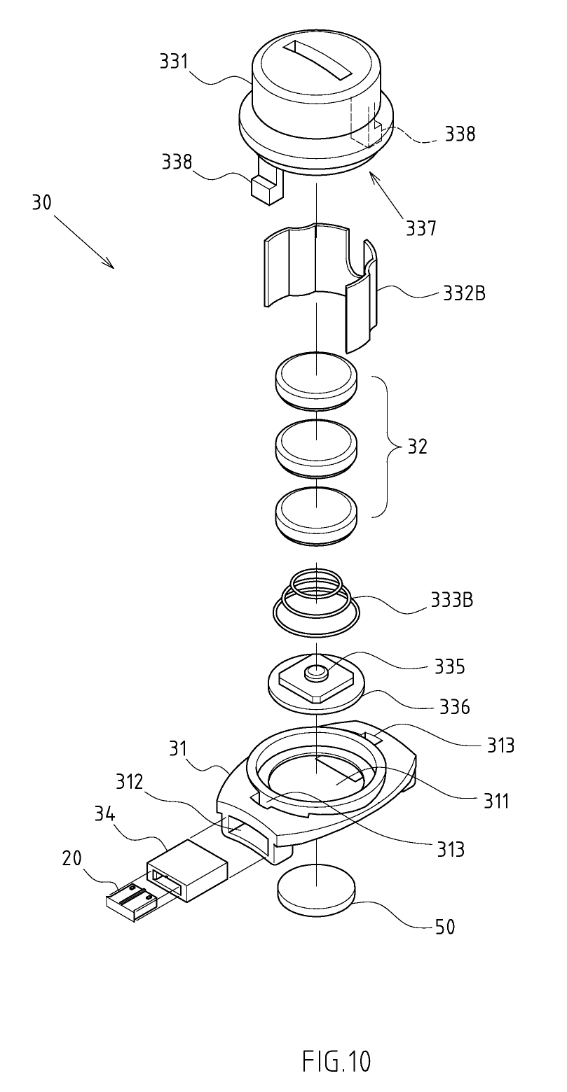

Referring also to FIG. 10, there is another application view of the local member of the power supply module 30, the difference with the power supply module 30 in FIG. 3, being that the conductive assembly 332B in the power supply module 30 is almost a half-angle cylinder. Thus, the battery 32 can be built in laterally. Additionally, the flexible bracing 333B of the conductive base 334 is a conical spiral spring for flexible support.

In addition to the decorative and warning models assembled on the cap as disclosed in FIGS. 7, 8, the LED strip light A of the present invention can also be applied to costume structure (e.g. outdoor working vest) or decorative structure (e.g. wristband and necklace) for the same decoration and warning purposes.

1. A light emitting diode (LED) strip light, comprising:
a flexible strip body, being comprised of a flexible FPC, a plurality of LEDs arranged at intervals on one side of flexible FPC, and a flexible light-transmitting layer adapted on one side of the flexible FPC, said flexible light-transmitting layer covering and sealing the LEDs and having an optical diffuse surface is formed thereon; and
an electrical connector, connected electrically to at least one end of said flexible FPC of said flexible strip body.

2. The LED strip light defined in claim 1, wherein said flexible strip body has an actual thickness of 1 mm-3 mm.

3. The LED strip light defined in claim 1, wherein said optical diffuse surface of flexible light-transmitting layer is of convex arc.

4. The LED strip light defined in claim 1, wherein said flexible strip body comprises a flash control IC electrically connected with said flexible FPC to control the flash mode of LED.

5. An LED strip light, comprising:
a flexible strip body, being comprised of a flexible FPC, a plurality of LEDs arranged at intervals on one side of a flexible FPC, and a flexible light-transmitting layer adapted on one side of the flexible FPC, said flexible light-transmitting layer covering and sealing the LEDs, and having an optical diffuse surface is formed thereon; and
at least an electrical connector, connected electrically to at least one end of said flexible FPC of said flexible strip body; and
a power supply module, comprising a base, a battery, a switching member and an electrical connection base, said electrical connection base being used for electrical connection by the electrical connector, providing a power supply required by LEDs of said flexible strip body.

6. The LED strip light defined in claim 5, wherein said flexible strip body has an actual thickness of 1 mm-3 mm.

7. The LED strip light defined in claim 5, wherein said optical diffuse surface of flexible light-transmitting layer is of convex arc.

8. The LED strip light defined in claim 5, wherein said LED strip light comprises a flash control integrated circuit (IC0, said flash control IC being assembled into said power supply module or said flexible strip body, thereby controlling the flash mode of the LED.

9. The LED strip light defined in claim 5, wherein said base of the power supply module comprises an upper groove and a lateral trough, said lateral trough being used for the assembly of electrical connection base, wherein said switching member comprises a push button, a conductive assembly, a conductive base with a plurality of flexible bracings, and a circuit board with press key, said push button being assembled onto said base for shifting to a predefined distance under pressure, and defining a hold tank to accommodate the battery, said conductive assembly being assembled into said hold tank and linked to periphery of the battery, said conductive base and circuit board being assembled into an upper groove of the base, and wherein said flexible bracing of the conductive base to supports the battery along with the push button, said press key of the circuit board being located correspondingly below the battery, said push button being pushed to make the battery fall down simultaneously, the press key being pressed down to control an on/off state of the power supply.

10. The LED strip light defined in claim 5, further comprising:
an L-shaped coupling LED and rotating groove arranged correspondingly between the push button and base, the push button being inserted and rotated for secure positioning.

11. The LED strip light defined in claim 5, further comprising:
a locating member mounted at a bottom of a base of said power supply module, said locating member is being formed of at least one of a group consisting of: a magnetic body, double-sided tape, fastening tape and adhesive.

12. The LED strip light defined in claim 5, further comprising:
a connection receptacle, being assembled at one end of the flexible strip body.

13. The LED strip light defined in claim 12, wherein said connection receptacle is further comprised of at least two electrical sockets, connecting said electrical connector of at least two flexible strip bodies for serial connection purposes.
